(19) United States
(12) Patent Application Publication
(10) Pub. No.: US 2008/0280699 A1
(43) Pub. Date: Nov. 13, 2008

(54) Water Repellant Golf Balls Containing a Hydrophobic or Superhydrophobic Outer Layer or Coating

(76) Inventor: Erik Jonas Jarvholm, Marietta, GA (US)

Correspondence Address: PATREA L. PABST;PABST PATENT GROUP LLP, 400 COLONY SQUARE, SUITE 1200, 1201 PEACHTREE STREET, ATLANTA, GA, 30361, US

(21) Appl. No.: 12/117,129

(22) Filed: May 8, 2008

Related U.S. Application Data
(60) Provisional application No. 60/916,705, filed on May 8, 2007.
(60) Provisional application No. 60/939,131, filed on May 21, 2007.

(51) Int. Cl. A63B 37/12; B32B 27/36; B32B 27/34

(52) U.S. Cl. 473/378; 428/412; 428/474.4; 428/484.1; 428/500; 428/523; 216/39

(57) ABSTRACT

Water-repellant, self-cleaning coatings and methods of making and using thereof are described herein. In one embodiment, a hydrophobic or super hydrophobic coating is applied to the surface of a golf ball to make the golf-ball water-repellant and self-cleaning. Suitable coating materials include silicone compounds, silicone compounds, nanoparticles, silanes, fluorocarbon polymers, perfluoroalkyl ethyl methacrylate (PPFEMA) coated polycaprolactone, hydrocarbons, polymer mats made of polystyrene and poly[tetrafluoroethylene-co-(vinylidene fluoride)-co-propylene] (PTVFP); polyethylene glycol with glucose and sucrose in conjunction with a hydrophobic substance; combinations of nanoparticles with polyethylene or polypropylene; high density polyethylene, technical waxes; films of rough particles of metal oxides, polymer binder layers containing a plurality of porous protrusions, and combinations thereof. Suitable coating techniques include, but are not limited to, spraying, dipping, painting, brushing, or wiping (such as applying the coating from a towel or sponge). The coating material or the outer layer of the golf ball may be modified to create nano- or micro roughness or patterns on the surface of the golf ball, which can induce the lotus effect. This roughness or pattern can be created using a variety of techniques known in the art including, but not limited to, etching, top/down methodologies, bottom/up methodologies, or combinations thereof.

### CROSS-REFERENCE TO RELATED APPLICATIONS

This application claims priority to U.S. Ser. No. 60/916,705, filed May 8, 2007 and U.S. Ser. No. 60/939,131, filed May 21, 2007.

### FIELD OF THE INVENTION

This invention relates generally to golf balls and, in particular, water-repellant, self-cleaning golf balls containing a hydrophobic or superhydrophobic outer coating or layer.

### BACKGROUND OF THE INVENTION

Playing golf in wet conditions (e.g., during rain, after rain, early in the morning (dew), and/or after watering of the fairways and/or greens) impacts the performance of the golf ball. Water trapped between the club face and the ball can negatively impact a variety of shots, including tee shots, shots from the rough and fairway, and putts, resulting in less control over the distance and direction of the shot as well as the amount of spin the player can impart to the ball.

Water also tends to collect in the dimples on the surface of the golf ball which can adversely affect the flight of the ball through the air. The dimples on the surface of the golf ball are designed to make the golf ball fly more efficiently through the air, thus increasing the distance and control of the shot. When water is present in the dimples, the ball does not travel as efficiently. Playing in rain will also impact both the distance and the control of shots as the rain drops hits the golf ball. On a wet green, the golf ball can become coated with water which results in more friction (compared to dry conditions) and drag between the ball and the surface resulting in a loss of distance and control. A schematic showing the behavior of water on the surface of an untreated golf ball is shown in FIG. 1.

An even worse situation for the player is when mud or dirt adheres to the surface of the golf ball. While a ball can be marked and cleaned when it is on the green, players generally cannot lift, clean and place their ball in the fairways, rough, or bunkers. The presence of dirt, mud, sand, or grass can adversely affect contact between the club face and the ball as well as the flight of the ball through the air and the roll of the ball over the greens resulting in a loss of control and distance.

Today's golf balls are made from several layers of different materials. These materials are developed for durability and to increase the playability (referred to as the “feel”) of the ball. The materials used for the most outer layer of the golf ball, however, are not sufficiently hydrophobic, with the result being that water, mud, dirt, sand, and/or grass can adhere to the ball causing the problems discussed above. There exists a need for golf ball that repels water and is self-cleaning.

Therefore, it is an object of the invention to provide water-repellant and self-cleaning coatings for golf balls, and methods of making thereof.

It is also an object of the invention to provide methods for modifying the outer-most layer of a golf ball to be water-repellant and self-cleaning.

### SUMMARY OF THE INVENTION

Water-repellant, self-cleaning coatings and methods of making and using thereof are described herein. In one embodiment, a hydrophobic or super hydrophobic coating is applied to the surface of a golf ball to make the golf-ball water-repellant and/or self-cleaning. Suitable coating materials include silicone compounds; silanes, nanoparticles, fluorocarbon polymers, perfluoroalkyl ethyl methacrylate (PPFEMA) coated polycaprolactone, hydrocarbons, polymer mats made of polystyrene and poly[tetrafluoroethylene-co-(vinylidene fluoride)-co-propylene] (PTVFP); polyethylene glycol with glucose and sucrose in conjunction with a hydrophobic substance; combinations of nanoparticles with polyethylene or polypropylene; high density polyethylene, technical waxes; films of rough particles of metal oxides, polymer binder layers containing a plurality of porous protrusions, and combinations thereof. Suitable coating techniques include, but are not limited to, spraying, dipping, painting, brushing, or wiping (such as applying the coating from a towel or sponge).

The coating material may be modified to create nano- or micro roughness or patterns on the surface of the golf ball, which can induce the lotus effect. In another embodiment, the outer most layer of the golf ball is modified to create nano- or micro roughness or patterns on the surface of the golf ball, which can induce the lotus effect. This roughness or pattern can be created using a variety of techniques known in the art including, but not limited to, etching, top/down methodologies, bottom/up methodologies, or combinations thereof.

In one embodiment, the percent difference in water absorbed on the surface of an untreated golf ball versus a coated or modified golf ball is greater 50%, preferably greater than 75%, more preferably greater 85%, most preferably greater than 90% by weight. In one embodiment, the percent difference is 82%. In another embodiment, the percent difference is 83%. In still another embodiment, the percent difference is 94%.

The hydrophobic or superhydrophobic coating or outer layer repels water, mud, dirt, sand, and/or grass from the surface of the golf ball resulting in a dry or relatively dry golf ball with optimal performance.

### BRIEF DESCRIPTION OF THE DRAWINGS

FIG. 1 is a schematic showing the adherence of water to the surface of a golf ball. Due to the lack of hydrophobicity or superhydrophobicity of the outer layer, the water droplet spreads over the surface of the golf ball, partially filling the dimples, resulting in a small contact angle and increased absorption.

FIG. 2 is a schematic showing the interaction of water with a hydrophobic or superhydrophobic coated golf ball. Due to the hydrophobicity of the surface, the water droplet beads up resulting in an increased contact angle and little water absorption on the surface.

FIG. 3 is a schematic of a water droplet on a micro-patterned surface. The effect of the roughness or pattern on the contact angle of water is explained by Cassie's law. The creation of a pattern or roughness creates a layer of air over the surface of the material. When the material is exposed to water, the layer of air acts a barrier preventing the water or other aqueous materials (e.g., dirt or mud) from adhering to the surface.

### DETAILED DESCRIPTION OF THE INVENTION

### I. Definitions

“Contact angle”, as used herein, refers to the angle at which a liquid/vapor interface meets the solid surface. The contact angle is specific for any given system and is determined by the interactions across the three interfaces. Most often the concept is illustrated with a small liquid droplet resting on a flat horizontal solid surface. The shape of the droplet is determined by the Young-Laplace equation. The contact angle plays the role of a boundary condition. Contact angle is measured using a contact angle goniometer. The contact angle can be expressed as the static water contact angle or the dynamic water contact angle. Unless otherwise specified, “contact angle”, as used herein, refers to the static water contact angle. The sessile drop method can be used to measure the static water contact angle. The sessile drop method is measured by a contact angle goniometer using an optical subsystem to capture the profile of a pure liquid on a solid substrate. The angle formed between the liquid/solid interface and the liquid/vapor interface is the contact angle. Older systems used a microscope optical system with a back light. Current-generation systems employ high resolutions cameras and software to capture and analyze the contact angle.

“Hydrophobic”, as used herein, refers to a coating or layer having a contact angle of greater than 90°.

“Superhydrophobic”, as used herein, refers to a coating or layer typically having a contact angle greater than 130°, preferably greater than 150°. Superhydrophobic materials have almost no contact between the liquid drop and the surface. This is sometimes referred to as the “Lotus effect”. The lotus effect refers to the superhydrophobic and self-cleaning property associate with the leaves of the lotus plant. Although lotuses prefer to grow in muddy rivers and lakes, the leaves and flowers remain clean. Botanists who have studied lotus leaves have found that they have a natural cleaning mechanism. The microscopic structure and surface chemistry of the leaves prevent them from being wetted by liquids having a contact angle of greater than 90° to an unstructured surface of the same material. With contact angles to water of up to 170°, droplets roll off a leafs surface like mercury, taking mud, tiny insects, and contaminants with them.

“Self-cleaning”, as used herein, refers to the ability of a golf-ball to repel water, mud, dirt, sand, and/or grass with little or no human intervention. For example, a self-cleaning ball can repel water, mud, dirt, sand and/or grass due to the hydrophobicity or superhydrophobicity of the coating or outer layer. Further, the force exerted by the wall while it is rolling on the ground or traveling in the air can remove water, dirt, mud, sand, and/or grass from the surface.

“Polymer”, as used herein, refers to oligomers, adducts, homopolymers, random copolymers, pseudo-copolymers, statistical copolymers, alternating copolymers, periodic copolymer, bipolymers, terpolymers, quaterpolymers, other forms of copolymers, substituted derivatives thereof, and combinations of two or more thereof. These polymers can be linear, branched, block, graft, monodisperse, polydisperse, regular, irregular, tactic, isotactic, syndiotactic, stereoregular, atactic, stercoblock, single-strand, double-strand, star, comb, dendritic, and/or ionomeric.

“Outer-most coating”, as used herein, refers to a coating of material that is applied to the surface of a two-piece or multilayer golf ball (e.g., three-piece or four-piece golf ball).

“Outer-most layer”, as used herein, refers to the outer most layer of a golf ball, for example, the outer most layer of the two layers in a two-piece golf ball, or the outer most layer of a multilayer golf ball (e.g., three-piece or four-piece golf balls). Two piece golf balls include, but are not limited to, double cover golf balls and Surlyn®-covered wound balls. Double cover golf balls contain a large, solid core with two layer covers. The outer cover is usually soft and the inner cover tends to be made from harder and sometimes heavier materials. Surlyn®-covered wound balls normally have a solid rubber center covered with a Surlyn® cover. Surlyn® is a commercial thermoplastic ionomer resin that was introduced by DuPont in the early 1960's. Surlyn® is the random copolymer poly(ethylene-co-methacrylic acid) (EMAA). Exemplary two piece golf balls include, but are not limited to, Callaway Warbird®; Pinnacle Gold®; Slazenger Raw Distance Fusion®; Top-Flite XL Pure Distance®; Wilson Jack®; Dunlop LoCo®; Maxfli Noodle®; Nike Power Distance Super Soft®; Precept Lady® and Laddie®; Titleist DT SoLo®; Callaway CB1® and HX 2-Piece®; Maxfli A3®; Slazenger Tour Platinum®; Srixon Hi-Spin® and Soft Feel®; Titleist NXT® and NXT Tour®; Top-Flite Infinity®; and Wilson True Velocity®.

Multilayer golf balls typically contain a small, liquid-filled or solid rubber core wrapped by rubber thread and then covered with a balata, urethane or balata-derivative cover. Multilayer golf balls include, but are not limited to, three piece urethane golf balls and four piece golf balls. Exemplary multilayer golf balls include, but are not limited to, Bridgestone B330® and B330-S®; Ben Hogan Apex Tour®; Callaway HX® and CTU 30®; Maxfli M3®; Nike TA2®, Double C® and One®; Precept U-Tri® and Tour Premium®; Srixon Pro UR® and UR-X®; Strata Series®; Titleist Pro V1® and Pro V1x®; Top-Flite Tour®; Wilson True Tour V® and Elite®.

“Lower alkyl” and “lower alkoxy” include C₁₋₅, preferably C₁₋₃, alkyl and alkoxy, such as methyl, ethyl, n-propyl, isopropyl, n-butyl, sec-butyl, t-butyl, amyl, isoamyl, methoxy, ethoxy, isopropoxy, isobutoxy, t-butoxy.

“Halogen”, as used herein, refers to fluorine, chlorine, bromine, and iodine.

“Linear or branched alkyl”, as used herein, refers to methyl, ethyl, n-propyl, isopropyl, n-butyl, sec-butyl, t-butyl, amyl, isoamyl, n-hexyl, 2-ethyl-n-hexyl, n-heptyl, n-octyl, isooctyl, n-nonyl, isononyl, n-dodecyl.

“Substituted alkyl”, as used herein, refers to cyanoalkyl, haloalkyl, hydroxyalkyl, alkoxyalkyl, preferably C₂₋₆, e.g., .beta.-cyanoethyl, beta.-chloroethyl, beta.-hydroxyethyl, .beta.-methoxyethyl, beta.-ethoxyethyl. Cyclo-alkyls include cyclopentyl, cycloheptyl, cyclohexyl, and may contain one or more C₁₋₄ alkyls.

“Aralkyl” and “alkaryl”, as used herein, refers to methylbenzyl, phenethyl, phenisopropyl, benzyl, and may be ring-substituted, such as with halogen, methyl, and/or methoxy, like p-methylbenzyl, o- or p-chlorobenzyl, o- or p-tolyl, xylyl, o-, m- or p-chlorophenyl, and o- or p-methoxyphenyl.

As referred to herein, heterocyclic radicals include pyrrolidinyl, piperidinyl, pipecolinyl, morpholinyl, thiomorpholinyl, piperazinyl (e.g., N-methylpiperazinyl).

As used herein, the term “derivatives” refers to various compounds chemically derivable from the parent compounds, typically sharing one or more chemical properties and/or reactivities with the parent compounds.

### II. Water-Repellant Golf Balls

Water-repellant and/or self-cleaning golf balls are described herein. In one embodiment, the golf balls are made water-repellant and/or self-cleaning by applying a hydrophobic or superhydrophobic coating to the golf ball. Alternatively, the outer layer of a two-piece or multilayer (e.g., three-piece or four-piece) golf ball can be modified to be hydrophobic or superhydrophobic.

A. Coatings

Golf balls can be coated with one or more hydrophobic or superhydrophobic coating. The hydrophobic or superhydrophobic materials can be organic, inorganic, or organometallic. Suitable hydrophobic or superhydrophobic materials include, but are not limited to, silicone compounds; silanes, such as trifunctionalized alkyl silanes; poly(dimethysiloxane); fluorocarbon polymers; mixtures of fluorocarbon polymers, a crosslinking agent and a plurality of particles functionalized with a functional group, wherein the functional group on the particles is essentially non-reactive with the fluorinated polymer and with the crosslinking agent as described in U.S. Patent Application Publication No. 20080015298 to Xiong et al.; perfluoroalkyl ethyl methacrylate (PPFEMA) coated polycaprolactone as described in U.S. Patent Application Publication No. 20070237947 by Gleason et al.; hydrocarbons; polymer mats made of polystyrene and poly[tetrafluoroethylene-co-(vinylidene fluoride)-co-propylene] (PTVFP); polyethylene glycol with glucose and sucrose in conjunction with a hydrophobic materials; combinations of nanoparticles with polyethylene or polypropylene; high density polyethylene (available under the tradename VYON®); technical waxes; films of rough particles of metal oxides as described in U.S. Pat. No. 5,500,216 to Julian et al., such as silicon dioxide treated with hexamethyldisilazane, silicon dioxide treated with dimethyldichlorosilane, or silicon dioxide treated with a polydimethyl siloxane polymer; polymer binder layers containing a plurality of porous protrusions as described in U.S. Patent Application Publication No. 20070141305 by Kasai et al.; and combinations thereof. The coating can be a monolayer or a thick film. The thickness of the coating is typically from about 0.1 microns to about 100 microns, preferably from about 0.1 microns to about 50 microns, more preferably from about 0.1 microns to about 25 microns.

In one embodiment, the coating exhibits the lotus effect. The lotus effect refers to the superhydrophobic and self-cleaning property associated with the leaves of the lotus plant. Although lotuses prefer to grow in muddy rivers and lakes, the leaves and flowers remain dry and clean. The microscopic structure and surface chemistry of the leaves prevent them from being wetted by liquids having a contact angle of greater than 90° to an unstructured surface of the same material. With contact angles to water of up to 170°, droplets roll off a leafs surface like mercury, taking mud, tiny insects, and contaminants with them. Therefore, hydrophobic or superhydrophobic coatings applied to golf balls can prevent them from being wetted by liquids having a contact angle of greater than 90°.

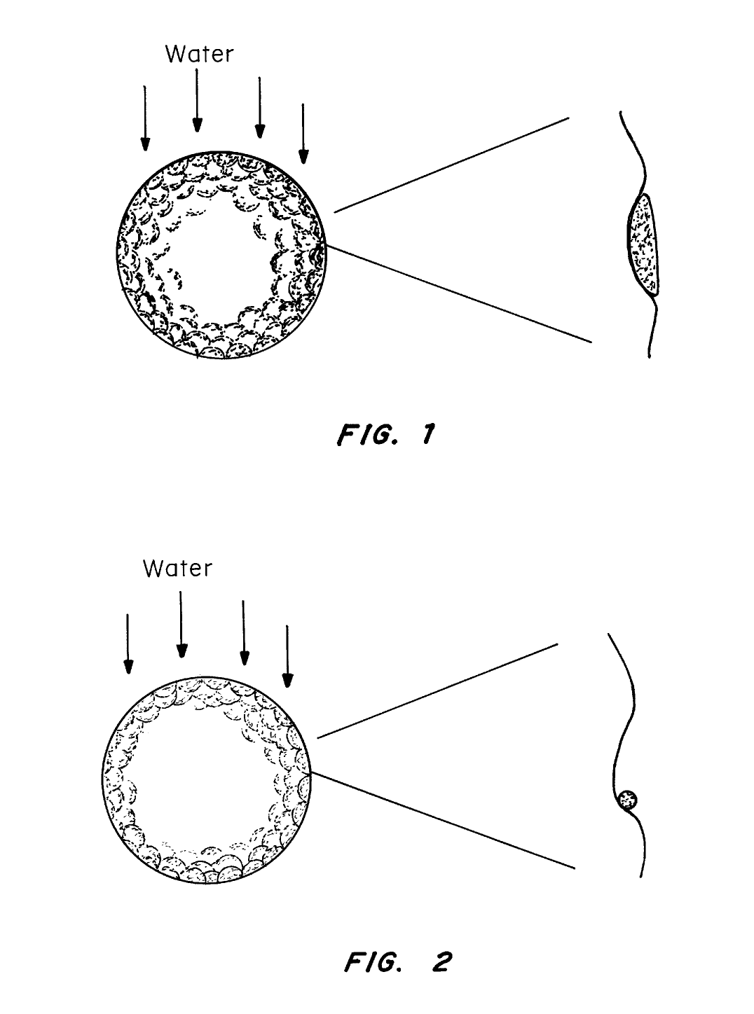

The lotus effect can also be induced in the coating by creating a nano- or microscale roughness or pattern on the surface of the material using one or more of the processes described below. A schematic showing this effect on the surface of a golf ball is shown in FIG. 2. Superhydrophobic coatings cause water the water droplet to bead up, minimizing its absorption on the surface and thus repelling the water droplet from the surface of the golf ball.

Alternatively, nanoparticles can be coated onto the surface of a golf ball or can be incorporated into the polymer coating to create a pattern or roughening. For example, a material developed at Oak Ridge National Laboratory, referred to as ORNL nano-structured material, can be coated onto the surface of the golf or incorporated into a hydrophobic or superhydrophobic polymer coating. The ORNL nano-structured material is a glass powder coating material which can be applied to any surface. It repels any water-based solution by creating a layer of air on the surface it is applied to. This layer of air is microscopically thin, but remains, even if the object is under water. The material is prepared by differential etching of two glass phases from phase-separated glass. The process starts out with a borosilicate phase in which the glass is separated as the base material, which is then heated for further separation. The resulting material is crushed into a powder. The powder is differentially etched in order to completely eliminate the interconnected borate glass phase. Lastly, the powder is treated with a special hydrophobic solution, which makes the glass surface hydrophobic. Through the differential etching the glass powder becomes porous and has nanoscale sharpened features.

Other nanoparticles materials include, but are not limited to, transparent films based on silica nanoparticles as described in Bravo et al., Langmuir, 23 (13), 7293-7298 (2007); superhydrophobic surfaces formed using layer-by-layer self-assembly with aminated multiwall carbon nanotubes as described in Liao et al., Langmuir, Mar. 7 (2008); and fluorinated iron-platinum (Fe/Pt) nanoparticles as described in Rotello et al., Adv. Mat., Vol. 19, No. 22, 4075-4079 (2007);

Water and or aqueous materials such as dirt, mud, sand, and/or grass adhere poorly to the coated golf ball. Further, as the ball travels through the air or along the ground, the forces exerted by the moving ball also help to remove water, dirt, mud, sand, and/or grass from the golf ball (i.e, self-cleaning).

2. Coating Additives

The coatings or layers can further contain one or more coating additives. Suitable additives include, but are not limited to, plasticizers, coloring agents or pigments, agents to inhibit UV degradation of the coating, additives that enhance adhesion of the coating to the golf ball, additives leveling and flow, impart slip and gloss, improve mar and/or cut resistance, additives to prevent pigment or colorant separation, and combinations thereof. The amount of these additives can be readily determined by one of ordinary skill in the art. The additives, if present, should not significantly affect the hydrophobic or superhydrophobic properties of the coating or layer.

### III. Methods of Making Golf Balls Water-Repellant and/or Self-Cleaning

A. Methods for Applying Hydrophobic or Superhydrophobic Coatings

The hydrophobic or superhydrophobic coating can be applied by the manufacturer during the production of the golf ball or it can be applied by the golfer himself, as needed, via coating techniques well known in the art. Suitable coating techniques include, but are not limited to, spraying, spray drying, spin coating, dipping, painting, brushing, or wiping (such as applying the coating from a towel or sponge). For example, if the coating is applied by the manufacturer, the coating can be sprayed onto the surface of the finished golf ball (e.g., spin coating). The material may be cured (e.g., crosslinked), if necessary, after application via thermal or photochemical processes. Nanoparticles can be incorporated into the coatings to enhance the hydrophobic or superhydrophobic properties of the coating. Alternatively, the nanoparticles themselves can be coated onto the surface of the golf ball using techniques well known in the art such as dip coating, spraying, painting, brushing, and various deposition techniques.

The concentration of the polymer dissolved in the solvent is typically between about 1 and 20% by weight, preferably between about 1 and about 10% by weight, more preferably between about 1% and about 5% by weight. In one embodiment, the concentration is about 3% by weight. However, the concentration of the polymer may be greater than 20% in other embodiments. If the coating has been applied as a solution or dispersion in an organic or aqueous solvent, the solvent can be removed via a variety of techniques including, but not limited to, evaporation.

The coating should be thin as not to influence the “feel” of the golf ball. The coating can be a monolayer or a thick film. The thickness of the coating is from about 0.1 microns to about 100 microns, preferably from about 0.1 microns to about 50 microns, more preferably from about 0.1 microns to about 25 microns. The thickness of the coating is typically determined based on durability and playability. The coating or layer may be modified as described below to create micro- or nanoscale roughness or patterns on the surface of the coating. In one embodiment, the roughness or pattern created induces the Lotus effect. The presence of the hydrophobic or superhydrophobic coating repels water, mud, dirt, etc. resulting in a dry golf ball with optimal performance.

In one embodiment, the percent difference in water absorbed on the surface of an untreated golf ball versus a coated or modified golf ball versus is greater 50%, preferably greater than 75%, more preferably greater 85%, most preferably greater than 90% by weight. In one embodiment, the percent difference is 82%. In another embodiment, the percent difference is 83%. In still another embodiment, the percent difference is 94%.

B. Method for Modifying the Outer Layer

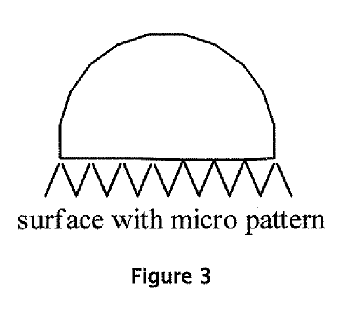

In another embodiment, the golf ball is made water-repellant and self-cleaning by modifying the existing outer layer of the golf ball. This can be done by creating nano- or micro roughness or patterns on the surface of the golf ball. This roughness or pattern can be created using a variety of techniques known in the art including, but not limited to, etching, top/down methodologies, bottom/up methodologies, or combinations thereof. In one embodiment, the roughness or pattern created induces the Lotus effect. A schematic of a patterned surface is shown in FIG. 3.

Top-down and bottom-up are two approaches used for assembling nanoscale materials and devices. Bottom-up approaches seek to have smaller (usually molecular) components arrange themselves into more complex assemblies, while top-down approaches seek to create nanoscale devices by using larger, externally-controlled devices to direct their assembly.

The top-down approach often uses the traditional workshop or microfabrication methods where externally-controlled tools are used to cut, mill and shape materials into the desired shape and order. Micropatterning techniques include, but are not limited to, wet and/or dry etching, photolithography and ink-jet printing.

Bottom-up approaches, in contrast, use the chemical properties of single molecules to cause single-molecule components to automatically arrange themselves into some useful conformation. These approaches utilize the concepts of molecular self-assembly and/or molecular recognition.

The effect of the roughness or pattern on the contact angle of water is explained by Cassie's law. Cassie's law describes the effective contact angle, θ_{c}, for a liquid on a composite surface. The law explains how simply roughing up a surface increases the apparent surface angle. The law is stated as:

cos θ_{c}=γ₁ cos θ₁+γ₂ cos θ₂

where by θ₁ is the contact angle for component 1 with areal fraction γ₁ and θ₂ is the contact angle for component 2 with areal fraction γ₂ present in the composite material. Cassie's research pointed out that the water repelling quality of ducks is due to the very nature of the composite formed between air and feather and not by other causes such as the presence of exceptional proofing agents like oils. Water striders also exploit this phenomenon. Artificial superhydrophobic materials such as nanopin film exist have been shown to illustrate this concept.

Alternatively, nanoparticles can be incorporated into the outer layer of the golf ball to create a layer that is hydrophobic or superhydrophobic. As discussed above, nanoparticles, such as ORNL nano-structured materials, can be applied to any surface. In this embodiment, the nanoparticles can be incorporated into the outer coating of the golf ball during manufacturing of the golf ball. The nanoparticles repel water, even when submerged, are durable, and are easy and inexpensive to manufacture.

Unless defined otherwise, all technical and scientific terms used herein have the same meanings as commonly understood by one of skill in the art to which the disclosed invention belongs. Publications cited herein and the materials for which they are cited are specifically incorporated by reference.

### EXAMPLES

### Example 1

### Preparation of Hydrophobic Golf Balls

Hydrophobic golf balls were made using the following procedure. A fluorocarbon polymer (Sartec H, available from Peachstate Labs; 3% in a fluorinated solvent), was sprayed evenly on to a golf ball using an aerosol sprayer. The solvent evaporated instantaneously and a thin white film is formed. The thin film was dried for 10 min at room temperature followed by heating with a stream of hot air from a hairdryer for 60 seconds. The heating melted the polymer resulting in the formation of a smooth transparent thin film. The coated golf ball was compared to a regular non-modified golf ball for water and mud repellency.

### Example 2

### Evaluation of the Water and Mud Repellency of a Hydrophobic Golf Ball

Water Drop Test

The golf ball prepared in Example 1 was evaluated for water and mud repellency. Using a syringe, a drop of water was left hanging from the outlet of the syringe. On a non-modified golf ball, the water drop transferred to the ball upon contact with the ball. In contrast, on the modified golf ball, the water drop was not transferred to the ball but stayed with the syringe due to the hydrophobic surface of the golf ball.

Blowing Test

In another experiment, a drop of water was placed on top of the hydrophobic golf ball. The water drop beaded up and flew off the surface of the ball when blowing lightly on the ball. On a non-modified ball, the water drop spread into a dimple and the droplet could not be removed from the surface when blowing on it lightly, the water instead spreading evenly over a larger area of the ball.

Static Water Weight Test

A modified ball was weighed. The weight was 45.49 g. The ball was immersed fully in water and removed. The ball was weighed again and the weight increased to 45.55 g. The change in the weight of the ball to the absorption of water was 0.06 g. A non-modified ball was weighed. The weight was 45.55 g. The ball was immersed in fully in water and removed. The ball was weighed again and the weight increased to 45.89. The change in the weight of the ball to the absorption of water was 0.34 g. The percent difference in the uptake of water of the two balls was 82% ((0.34−0.06)/0.34*100%=82% less water was on the surface of a modified golf ball versus a non-modified golf ball due to the hydrophobic coating).

Dynamic Water Weight Test

4. The same balls used in the static water weight test were used to measure the water uptake on the surface under running water. A faucet was used to provide the running water and the flow of water was kept constant. The modified ball was weighed before and after exposure to the running water, 45.49 g before and 45.56 g after (0.07 g of water on the surface). The same was done for the non-modified ball, 45.55 before and 45.95 after (0.40 g of water on the surface. (0.40−0.07)/0.40*100%=82% less water was on the surface of a modified golf ball versus a non-modified golf ball due to the hydrophobic coating.

The same balls used in the static water weight test were used to measure the water uptake when rolled on a wet lawn. The balls were rolled 10 feet on a wet lawn. The modified ball was weighed before and after exposure to the wet lawn, 45.49 g before and 45.50 g after (0.01 g of water on the surface). The same was done for the non-modified ball, 45.55 before and 45.71 after (0.16 g of water on the surface. (0.16−0.01)/0.16*100%=94% less water was on the surface of a modified golf ball versus a non-modified golf ball due to the hydrophobic coating.

The same balls used in the static water weight test were used to measure the mud and water uptake when dropped into mud from 4 feet. The modified ball was weighed before and after exposure to the mud, 45.49 g before and 45.53 g after (0.04 g of water and mud on the surface). The same was done for the non-modified ball, 45.55 before and 45.79 after (0.24 g of water and mud on the surface. (0.24−0.04)/0.24*100%=83% less water and mud was on the surface of a modified golf hall versus a non-modified golf ball due to the hydrophobic coating.

I claim:

1. A water-repellant golf ball comprising a hydrophobic or superhydrophobic coating or outer layer.

2. The golf ball of claim 1, wherein the hydrophobic or superhydrophobic coating comprises a polymer selected from the group consisting of silicone compounds; silanes, fluorocarbon polymers, perfluoroalkyl ethyl methacrylate (PPFEMA) coated polycaprolactone, hydrocarbons, polymer mats made of polystyrene and poly[tetrafluoroethylene-co-(vinylidene fluoride)-co-propylene] (PTVFP); polyethylene glycol with glucose and sucrose in conjunction with a hydrophobic substance; combinations of nanoparticles with polyethylene or polypropylene; high density polyethylene, technical waxes; films of rough particles of metal oxides, polymer binder layers containing a plurality of porous protrusions, and combinations thereof.

3. The golf ball of claim 1, wherein the coating is a layer or layers of nanoparticles.

4. The golf ball of claim 1, wherein the thickness of the coating or layer is from about 0.1 microns to about 100 microns.

5. The golf ball of claim 1, wherein the coating induces the lotus effect.

6. The golf ball of claim 1, wherein the outer layer of the golf ball has been modified to be hydrophobic or superhydrophobic.

7. The golf ball of claim 6, wherein the outer layer has incorporated therein nanoparticles which are hydrophobic or superhydrophobic.

8. The golf ball of claim 6, wherein the outer layer of the golf ball is made hydrophobic or superhydrophobic by creating nano- or micro roughness or patterns on the surface of the golf ball.

9. The golf ball of claim 1, wherein the coating further comprises one or more coating additives selected from the group consisting of plasticizers, coloring agents or pigments, agents to inhibit UV degradation of the coating, additives that enhance adhesion of the coating to the golf ball, additives leveling and flow, impart slip and gloss, improve mar and/or resistance, additives to prevent pigment or colorant separation, and combinations thereof.

10. A method for making a water repellant golf ball the method comprising applying a hydrophobic or superhydrophobic coating to the surface of the golf ball or modifying the outer most layer of a golf ball to be hydrophobic or superhydrophobic.

11. The method of claim 10, wherein the hydrophobic or superhydrophobic coating comprises a polymer selected from the group consisting of silicone compounds; silanes, fluorocarbon polymers, perfluoroalkyl ethyl methacrylate (PPFEMA) coated polycaprolactone, hydrocarbons, polymer mats made of polystyrene and poly[tetrafluoroethylene-co-(vinylidene fluoride)-co-propylene] (PTVFP); polyethylene glycol with glucose and sucrose in conjunction with a hydrophobic substance; combinations of nanoparticles with polyethylene or polypropylene; high density polyethylene, technical waxes; films of rough particles of metal oxides, polymer binder layers containing a plurality of porous protrusions, and combinations thereof.

12. The method of claim 10, wherein the thickness of the coating or layer is from about 0.1 microns to about 100 microns.

13. The method of claim 10, wherein the coating induces the lotus effect.

14. The method of claim 10, wherein the outer layer of the golf ball has been modified to be hydrophobic or superhydrophobic.

15. The method of claim 14, wherein the outer layer has incorporated therein nanoparticles which are hydrophobic or superhydrophobic.

16. The method of claim 10, wherein the outer layer of the golf ball is made hydrophobic or superhydrophobic by creating nano- or microroughness or patterns on the surface of the golf ball.

17. The method of claim 16, wherein the roughness or pattern is created by a process selected from the group consisting of etching, top/down methodologies, bottom/up methodologies, or combinations thereof.

18. The method of claim 17, wherein the technique is a top/down methodology selected from the group consisting of wet and/or dry etching, photolithography and ink-jet printing.

19. The method of claim 10, wherein the coating further comprises one or more additives selected from the group consisting of plasticizers, coloring agents or pigments, agents to inhibit UV degradation of the coating, additives that enhance adhesion of the coating to the golf ball, additives leveling and flow, impart slip and gloss, improve mar and/or resistance, additives to prevent pigment or colorant separation, and combinations thereof.
